(19) United States
(12) Patent Application Publication
(10) Pub. No.: US 2024/0388925 A1
(43) Pub. Date: Nov. 21, 2024

(54) SYSTEM, METHOD, AND MEDIUM FOR MOBILE NETWORK EXPANSION USING AN AUTONOMOUS VEHICLE

(71) Applicant: RAKUTEN SYMPHONY, INC., Tokyo (JP)

(72) Inventor: Ahmed DARWISH, Tokyo (JP)

(73) Assignee: RAKUTEN SYMPHONY, INC., Tokyo (JP)

(21) Appl. No.: 18/041,568

(22) PCT Filed: Nov. 30, 2022
(86) PCT No.: PCT/JP2022/044115

§ 371 Date: Feb. 14, 2023

(51) Int. Cl. H04W 16/26; G01C 21/26; H04W 12/06; H04W 24/02

(52) U.S. Cl. CPC H04W 16/26; G01C 21/265; H04W 12/06; H04W 24/02

(57) ABSTRACT

A method for expanding a mobile network via an autonomous vehicle includes receiving a network expansion request comprising configuration data, mapping a network expansion site, generating a set of computer navigation instructions to be used by the autonomous vehicle to set up a microwave link and a radio network node for expanding the mobile network, selecting an autonomous vehicle, deploying the selected autonomous vehicle to the network expansion site to autonomously set up the microwave link and the radio network node.

### CROSS REFERENCE TO RELATED APPLICATIONS

This application is a National Stage of International Application No. PCT/JP2022/044115 filed on Nov. 30, 2022.

### TECHNICAL FIELD

The present disclosure generally relates to the field of mobile data networks and, in particular, to the automated expansion of mobile data networks using autonomous vehicles.

### BACKGROUND

In the current mobile network architecture, transmission hardware such as microwave (MW) links or fiber cables are used to connect Evolved Node B (eNB) and Next Generation Node B (gNB) radio nodes with a core network.

Microwave transmission devices, such as microwave antennas, are at endpoints in a communication network and transmit data wirelessly between separate network segments or different networks. These devices send information between two points using beams of electromagnetic energy in a line-of-sight; that is, the electromagnetic beams are transmitted in a straight line between two microwave antennas.

Misalignment of two microwave antennas can weaken the transmission signal between them. A weakened transmission signal can result in dropped data connections, which can strain other network hardware and frustrate network users. Misalignment can occur due to improper initial alignment or other causes, such as weather, natural disasters, and foreign objects striking the antennas. If the antennas become misaligned, teams of engineers must be sent to the sites to re-align the antennas.

Network expansion has been conducted using manned vehicles to set up network nodes associated with mobile communication networks on a temporary or permanent basis. However, as communication networks are increasingly needed in areas that are not accessible by manned vehicles, for example, because of size constraints of the vehicles, danger to human drivers, and the like, a need has arisen for automatic network node set up in areas which are inaccessible by manned vehicles or in cases when manned vehicle network expansion is otherwise not available.

### BRIEF DESCRIPTION OF DRAWINGS

Aspects of the present disclosure are best understood from the following detailed description when read with the accompanying figures. It is noted that, per the standard practice in the industry, various features are not drawn to scale. The dimensions of the various features may be arbitrarily increased or reduced for clarity of discussion.

FIG. 1 is a schematic view of a system implementing a method for mobile network expansion using an autonomous vehicle.

FIG. 2 is a flowchart of a method for mobile network expansion using an autonomous vehicle.

FIG. 3 is a flowchart of a method for the alignment of a microwave antenna equipped to an autonomous vehicle.

FIG. 4 is a block diagram of a system for implementing a method for mobile network expansion using an autonomous vehicle.

### DETAILED DESCRIPTION

The following disclosure provides many different embodiments, or examples, for implementing various features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the connection of a first feature to a second feature in the description that follows may include embodiments in which the first and second features are directly connected and may also include embodiments in which additional features may be connected between the first and second features, such that the first and second features may not be in direct connection. In addition, the present disclosure may repeat reference numerals or letters in the various examples. This repetition is for simplicity and clarity and does not dictate a relationship between the various embodiments or configurations discussed.

Network expansion, using manned vehicles such as cars and the like, helps a service provider expand a network temporarily or on short notice. A vehicle can be fitted with network equipment (e.g., microwave antenna(s), radio transmitters) capable of expanding an existing network or setting up a new network. The vehicles are typically driven by human drivers on public roads, for example, to bring a team to a network installation site quickly. Manned vehicles, such as cars and trucks, are restricted to areas where these vehicles can travel, such as public and private roads, and cannot conduct network expansion in areas where these vehicles cannot travel. Further, manned vehicle network expansion may also be restricted in areas where the risk to human life is too high to conduct network expansion, such as disaster areas, dangerous mountain roads, icy surfaces, and the like. Additionally, the number of vehicles available to expand or set up a new network is restricted to the number of human drivers available.

In contrast, network setup or expansion using an autonomous vehicle (i.e., autonomous) will help with the flexibility, availability, accuracy, and precision of network expansion or new network setup. Because autonomous vehicles are not required to accommodate a driver, and the loss of a vehicle does not endanger a driver (because there is no driver), autonomous vehicles can conduct network expansion or setup in areas inaccessible to manned vehicles and provide a greater amount of flexibility that is not possible with manned vehicle network setup or expansion. This helps to improve network expansion or setup while also increasing safety and reducing deployment times. By improving network expansion and setup, network node locations can be adjusted more effectively to provide enhanced (e.g., increased) network coverage and service (e.g., higher network speed and increased network reliability) over conventional methods.

In this application, an autonomous vehicle is a vehicle that is capable of fully autonomous navigation without human intervention. In some embodiments, autonomous vehicles, according to this disclosure, are capable of being automatically deployed, conducting network node setup autonomously, and returning to a parking location designated in advance or designated in real-time.

Radio nodes (e.g., eNB and gNB nodes) can be used to expand coverage of wireless networks such as Radio Access Networks (RANs) and other types of networks that are used to provide wireless mobile access data services such as fourth-generation (4G) and fifth-generation (5G) wireless services. User access to these networks is provided via radio nodes connected to a core network and wirelessly communicate with user equipment such as mobile phones and other similar devices. In some approaches, radio nodes are connected to the core network via a microwave link. In some approaches, the radio node is connected to a core network via a fiber optic connection. In some approaches, the radio node is connected to a core network via a microwave link and fiber optic connections. Radio nodes connected using microwave links or fiber optic connections require that these links and connections are available and accessible from where the radio node is placed.

In this application, a core network is a central part of a more extensive mobile network that allows subscribers access to network services that the subscribers are permitted to use. The core network includes nodes that represent a user plane (also referred to as “data plane” in this application) of the mobile network, such as a serving gateway (SGW), packet data network gateway (PGW), and a control plane of the network, such as a mobility management entity (MME). The control plane handles network messaging and signaling and is part of the routing architecture of the network that helps define network topology. In contrast, the user plane handles data traffic and the like.

In some embodiments, the mobility management entity handles signals between active UEs and the network within a long-term evolution (LTE) and evolved packet core (EPC) architecture. The mobility management entity is also responsible for signaling between eNodeBs and the core network. In some embodiments, the mobility management entity is located at an edge of an LTE and EPC network. In some embodiments, the mobility management entity authenticates user equipment by communicating with a home subscriber service (HSS). The mobility function allows the user equipment to access the network and keeps track of its location and state. The home subscriber service is a central database that contains relevant details about a user equipment subscriber' s information and user authentication. The home subscriber server also provides information for calls and IP session setup. This server helps service providers manage the information of their subscribers in real-time. A mobile network can operate with only one HSS, but more than one can be used. If there are two or more HHS, the HHS servers synchronize their databases so that information is consistent across the multiple HHS databases.

Alignment of microwave data links helps to maintain network integrity and performance. A reliable and fast network provides users with an enjoyable experience. For example, networks that drop connections and have low data rates can frustrate network users, resulting in the cancellation of network service contracts. Microwave antennas in proper alignment achieve a higher signal level, resulting in higher data throughput between the antennas. Further, microwave antennas that can quickly realign after being taken out of alignment can help to increase network integrity and robustness. Some approaches rely on two teams of engineers, one for the setup and alignment of a first microwave antenna and the second for the setup and alignment of a second antenna to produce a data connection between the first and second antennas. In this approach, the teams must coordinate with each other as they move the microwave antennas to attempt to align them. Each time an antenna is moved, the signal must be measured by at least one of the teams. If the signal is not sufficiently strong, the teams must continue moving the antennas, measuring the signal level, and confirming the measurements with the other team. This process is repeated any time the antennas fall out of alignment.

In contrast, a system for microwave antenna alignment that employs a blockchain network and Artificial Intelligence (A.I.) for position determination and alignment of the microwave antennas is capable of self-aligning and executing re-alignment when the antennas fall out of alignment without the need for calling an engineering team to the antenna sites after every incident of misalignment.

In this application, microwave antennas are not aligned (or misaligned) when a received signal level (RSL) between antennas is below an acceptable predetermined threshold. For example, the RSL can be measured in decibels per milliwatt (dBm). In some embodiments, the system takes measurements associated with the positioning of at least one of the microwave antennas and measures an RSL associated with that position. Position data and the associated RSL are stored in computer memory and compared with measured RSLs for different antenna positions to find an RSL sufficient for acceptable data transfer using the microwave antenna. In some embodiments, antenna positional data is obtained using sensors connected to the antennas. In some embodiments, antenna positional data includes one or more of antenna latitude, antenna longitude, antenna vertical degree (e.g., vertical angle measured in degrees), or antenna horizontal degree (e.g., horizontal angle measured in degrees). An acceptable RSL depends on the specifications of individual networks or network equipment. For example, an acceptable RSL may range from −40 dBm to −35 dBm. Other acceptable RSLs may be higher or lower depending on the specifications of individual networks or network equipment. Once an acceptable RSL is achieved between the antennas, the position data is set, and the antenna positions are locked. If the antennas come out of alignment, that is, when the measured RSL is less than a predetermined RSL, the antennas will repeat the automatic alignment process until the measured RSL is greater than or equal to the predetermined RSL representing an acceptable RSL between the antennas. In some embodiments, the microwave antennas are positioned using a motor. In some embodiments, an antenna may include one or more motors. In some embodiments, the motor is a 2-axis motor. In some embodiments, the motor used is other than a 2-axis motor. In some embodiments, a controllable device other than a motor, sufficient for positioning the antenna, may be used.

Table 1 below is an exemplary representation, according to some embodiments, of the stored data associated with antenna positioning and RSL. In some embodiments, a portion or all of this data is broadcast to the blockchain network.

TABLE 1

| | Antenna | Antenna | Antenna | Link | Antenna | Antenna | Antenna |
|---|---|---|---|---|---|---|---|
| | A | A | A | RSL | B | B | B |
| | Vertical | Horizontal | Elevation | Value | Vertical | Horizontal | Elevation |
| | Degree | Degree | (cm) | (dBm) | Degree | Degree | (cm) |
| Initial | 95 | 40 | 3500 | −40 dBm | 85 | 120 | 4000 |
| RSL | | | | | | | |
| | . . . | . . . | . . . | . . . | . . . | . . . | . . . |
| Best | 96 | 41 | 3510 | −32 dBm | 84.5 | | 4020 |
| RSL | | | | | | | |
| | 94 | 39 | 3505 | −35 dBm | | | 4025 |

In some embodiments, an A.I. module selects a single vehicle for the setup of a microwave antenna network link. In some embodiments, the A.I. module selects more than one vehicle. In some embodiments, the A.I. module uses a decision tree algorithm to select a vehicle sufficiently close to a predetermined installation site of a microwave antenna. In some embodiments, the A.I. module may apply a K-Nearest Neighbors (KNN) algorithm. In some embodiments, the A.I. module may apply a different decision tree algorithm. In some embodiments, the A.I. module may apply an algorithm other than a decision tree algorithm.

In some embodiments, once two microwave antennas are set up as network links, and before the antennas join the blockchain network, the A.I. module broadcasts to the blockchain network that two new links will be installed. In some embodiments, the A.I. module will provide an estimated time for the completion of the installation. In some embodiments, the A.I. module applies a “Deep Estimated Time of Arrival” (DeepETA) algorithm. In some embodiments, the A.I. module applies an algorithm other than the DeepETA algorithm to estimate installation time.

In some embodiments, once the two microwave antennas are installed and set up as network links, the A.I. module calculates initial positions for each antenna and then sets additional positions for the antennas to be used in an alignment process. The A.I. module directs motors in the two antennas to set the antenna positions to the calculated positions, and at each position, an RSL is measured between the two antennas. In some embodiments, the A.I. module predicts an optimal RSL. In some embodiments, the A.I. module selects an optimal RSL from a database of stored measured RSL values taken at each antenna position during the alignment process. In some embodiments, the A.I. module applies a deep learning algorithm such as Recurrent Neural Network (RNN) learning to select and predict an optimal RSL. In some embodiments, the A.I. module applies a Long Term Short Term Memory (LSTM) based RNN algorithm to select or predict an optimal RSL. In some embodiments, the A.I. module applies an algorithm other than an RNN algorithm to select or predict an optimal RSL.

In some embodiments, data transmission microwave antenna links on the blockchain network are classified or prioritized by the A.I. module according to a classification algorithm. In some embodiments, the A.I. module classifies or prioritizes transmission links based on traffic, capacity, or link importance using the classification algorithm. In some embodiments, preferred and alternative microwave link paths are determined using the A.I. module's classification algorithm.

In some embodiments, new blocks on the blockchain network are created, corresponding to the microwave antennas installed and connected to the network. In some embodiments, the new blocks are created using a consensus method. The consensus method is based on the concept that existing network participants have already gained permission to be part of the network and that the participants involved in a transaction can confirm the transaction. Master nodes on the blockchain network act as administrators that grant permissions to other nodes joining the network. These master nodes may be selected based on hardware configuration or type (e.g., RAM, CPU, or other memory type(s)). For example, a device with more powerful hardware or memory may be more likely to be selected as a master node. In some embodiments, selective endorsement is applied as the consensus method through smart contracts to distributed ledgers in the blockchain network. In some embodiments, the consensus method approves the addition of the blocks to the network that represent the microwave links. Information associated with the microwave links is distributed throughout the blockchain through smart contracts to distributed ledgers in the network. In some embodiments, a smart contract includes a program code stored in the blockchain that runs when a predetermined condition is met. In some embodiments, a smart contract can be triggered when a new node (e.g., a new microwave antenna link) is connected to the network. In some embodiments, when the smart contract is triggered, data associated with the new node is distributed to other nodes on the network, and the data is recorded in distributed ledgers. In some embodiments, a smart contract is triggered in response to a change in the network, such as having a node switched on or off, a node going down, or a change in the configuration of a node. In some embodiments, a smart contract is triggered based on a schedule, such as network updates being conducted every ten minutes. In some embodiments, a distributed ledger is a shared and synchronized database across all blockchain network nodes. In some embodiments, distributed ledgers are accessible by all nodes, including master (admin) nodes, which verify data recorded in the distributed ledgers. In some embodiments, distributed ledgers store data such as link design, antenna configuration, antenna location, position and direction of an antenna, link status, link alarms, and the like.

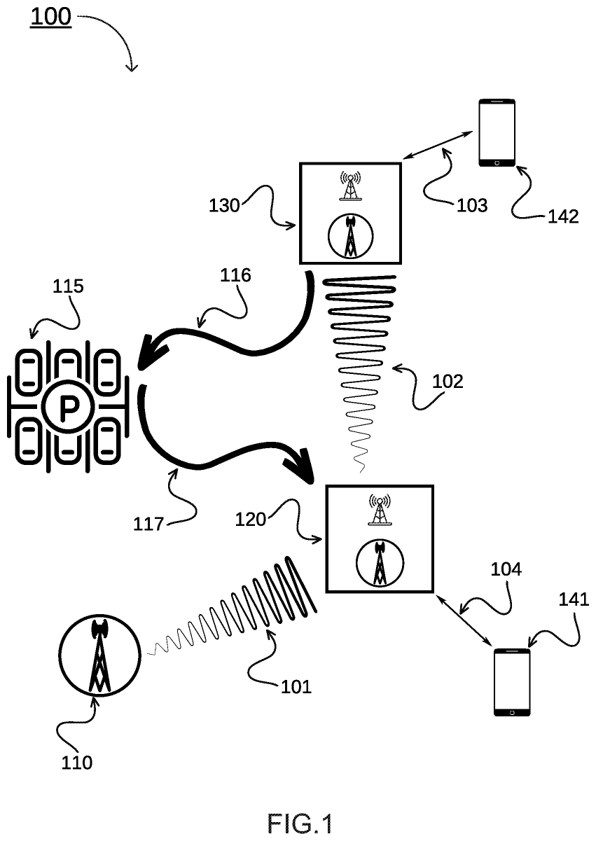

FIG. 1 is a schematic view of system 100 for implementing method 200 for expanding a network via autonomous vehicle in accordance with some embodiments. A microwave antenna 110, connected to a core network (not shown), is connected to a microwave antenna installed to autonomous vehicle 120 via microwave signals 101. Autonomous vehicle 120 includes radio equipment for broadcasting a mobile wireless network (e.g., 2G-5G, etc.) to user equipment (UE) 141 via radio signals 104. Autonomous vehicle 120 creates a network link with a microwave antenna installed to autonomous vehicle 130 via microwave signals 102. Autonomous vehicle 130 includes a microwave antenna and radio equipment for broadcasting a mobile wireless network (e.g., 2G-5G, etc.) to user equipment (UE) 142 via radio signals 103. In some embodiments, autonomous vehicle 130 connects directly to microwave antenna 110. Autonomous vehicles are stored in and deployed from parking area 115. Path 116 represents a return path associated with autonomous vehicle 130. For example, when a network node created by autonomous vehicle 130 is no longer needed, autonomous vehicle 130 is called back to parking area 115. Path 117 represents a deployment path of vehicle 120.

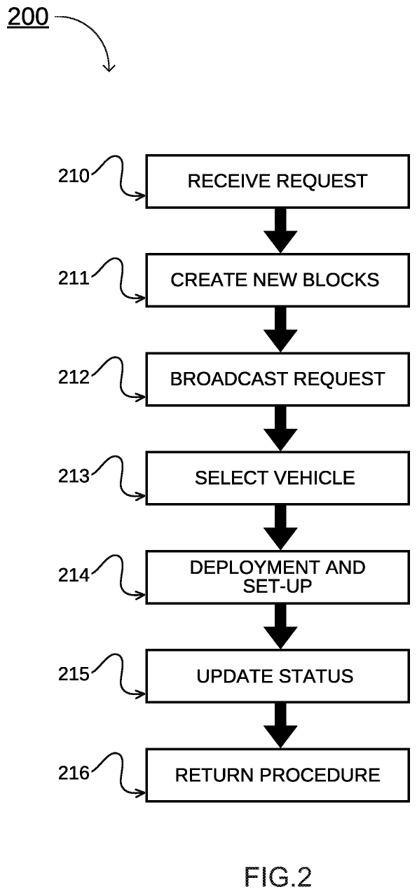

FIG. 2 is a flowchart of method 200 for mobile network expansion using an autonomous vehicle equipped with a microwave antenna according to some embodiments. In operation 210, an A.I. module connected to a private blockchain network receives a request to add a new network node to expand or replace a node on a network. The request includes a location for the network node and configuration information associated with a microwave link. In some embodiments, the request also includes a radio site configuration or an antenna configuration.

In operation 211, new blocks on the blockchain network are created that are associated with the request information, and at least one smart contract is generated associated with the vehicle request. In some embodiments, the new blocks are created by a consensus process. In some embodiments, the consensus process is by selective endorsement.

In operation 212, the A.I. module broadcasts the received request to the blockchain network.

In operation 213, the A.I. module selects an autonomous vehicle based on a classification algorithm. The classification algorithm uses data such as the surrounding environment, road type(s), vehicle availability, vehicle range, traffic, and the like to select the autonomous vehicle. Once the vehicle is selected, the A.I. module updates the private blockchain to include the selected vehicle information. Selected vehicle information may include vehicle starting location, vehicle ending location, site configuration information, and the like.

In operation 214, the autonomous vehicle is deployed to a predetermined location associated with the received request. The A.I. module provides route detailed and navigation information to the vehicle and updates the blockchain with an estimated time of arrival (ETA) to the predetermined location associated with the request. In some embodiments, ETA information is updated in real-time. In some embodiments, the A.I. module applies an algorithm such as deepETA to provide ETA information. Once the vehicle arrives at the predetermined location, it will set up and configure a network node according to the information associated with the received request. Set up and configuration may include setting up a microwave (MW) link, including alignment, setting up a radio node, or both.

In operation 215, once the network node is set up and configured, the vehicle updates the blockchain so that all nodes on the blockchain network know the network node has been installed and configured. In some embodiments, the A.I. module will also send the update to at least one predetermined recipient, for example, via email or another communication method.

In operation 216, the autonomous vehicle powers off and disconnects the network node. In some embodiments, operation 216 is triggered by the expiration of a timer or other trigger included in the received request. In some embodiments, operation 216 includes the autonomous vehicle moving to a predetermined location different from the network site. In some embodiments, operation 216 is optional.

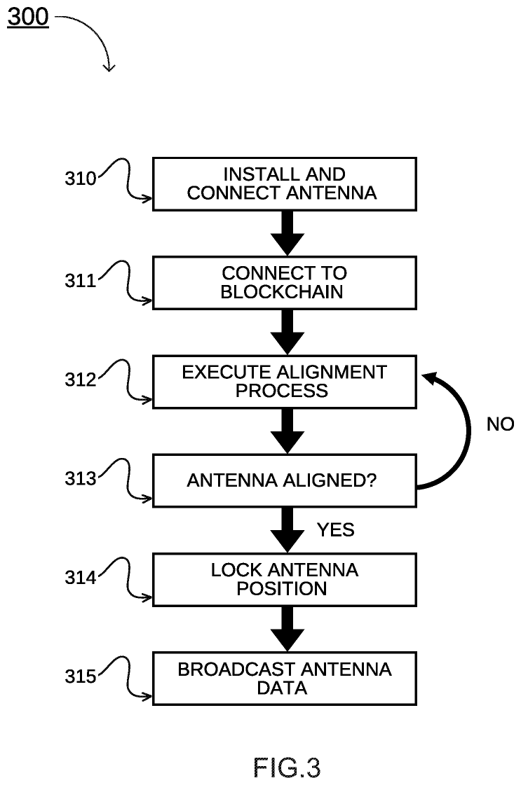

FIG. 3 is a flowchart of method 300 for the alignment of a microwave antenna equipped to an autonomous vehicle in accordance with some embodiments. Method 300 employs blockchain and A.I. technology so that an autonomous vehicle equipped with the microwave antenna can set up a microwave link that automatically aligns and maintains alignment. This helps the autonomous vehicle set up and maintain a robust connection with high data throughput. Further, the autonomous vehicle realigns its microwave antenna automatically in the event of misalignment. The microwave antenna is treated as a block on the blockchain. All other autonomous vehicles on the blockchain network can share data associated with positioning, location, alignment, and the like.

In operation 310, once the autonomous vehicle has reached the predetermined location associated with the received request, its first microwave antenna is set up and connected to the internet by the autonomous vehicle. In some embodiments, the first microwave antenna connects to a network other than the internet, such as a private network. After installing the first antenna and connecting the antenna to a network, the autonomous vehicle aligns the first microwave antenna with a second predetermined microwave antenna to create a microwave link.

In operation 311, the first and second microwave antennas connect to a blockchain network. Other nodes on the blockchain network are configured to authenticate the first and second microwave antennas and authorize the antennas as new nodes on the blockchain network. In some embodiments, the first and second microwave antennas each have a unique private key to connect to the blockchain network. Once the first microwave antenna is connected to the blockchain network, it downloads blockchain data, including, but not limited to, ledgers and network transactions. In some embodiments, the first microwave antenna downloads all available blockchain data on the network, including ledgers and all transactions. Once the second microwave antenna is connected to the blockchain network, it downloads blockchain data, including, but not limited to, ledgers and network transactions. In some embodiments, the second microwave antenna downloads all available blockchain data on the network, including ledgers and all transactions. In some embodiments, while the first and second microwave antennas are connected to the blockchain network, each antenna collects real-time data via sensors, including positional data including, but not limited to, latitude of the antenna, longitude of the antenna, altitude of the antenna, vertical angle of the antenna, and horizontal angle of the antenna. In some embodiments, the data is not collected in real time. In some embodiments, vertical and horizontal angles are measured relative to the Earth. In some embodiments, vertical and horizontal angles are measured relative to reference axes other than the Earth. In some embodiments, the sensors are installed on the antennas. In some embodiments, the sensors are installed in locations other than the antennas. In some embodiments, the collected data is broadcast to the blockchain network. In some embodiments, the collected data is broadcast to the blockchain network after new blocks representing the first and the second microwave antennas are created. In some embodiments, the new blocks are created using a consensus process. In some embodiments, the new blocks are created using selective endorsement and through smart contracts to all distributed ledgers in the blockchain network. In some embodiments, the first and second microwave antennas store data indicating that the first and second antennas are part of the same network link. They each know the other's positional information, including latitude, longitude, altitude, vertical angle, and horizontal angle.

In operation 312, an A.I. module determines initial positions for the first and second microwave antennas using a positioning algorithm to generate position and direction parameters. The position and direction parameters are uploaded to the blockchain network and made accessible to the first and second microwave antennas. The first and second microwave antennas download the positioning data and apply the parameters, thereby adjusting their positioning. In some embodiments, the antenna positions are adjusted using at least one motor attached to each of the first and second microwave antennas. In some embodiments, the motors are 2-axis motors. In some embodiments, the motors are of a type other than 2-axis. In some embodiments, the antennas are adjusted using means other than motors, such as hydraulics. Once the first and second microwave antennas are set to their respective initial positions, an initial received signal level (RSL) is obtained by either or both of the first and second microwave antennas and automatically stored in a memory. In some embodiments, the initial RSL is recorded in both directions. The initial RSL is compared with a predetermined RSL. The predetermined RSL corresponds to a link design value that is set based, in part, on the performance parameters of the microwave link.

In operation 313, the initial RSL is compared with the predetermined RSL. If the initial RSL is determined to be greater than or equal to the predetermined RSL, operation 314 is carried out. If the initial RSL is determined to be less than the predetermined RSL, operations 312 and 313 are carried out until a measured RSL is greater than or equal to the predetermined RSL.

In operation 314, upon a determination that the initial RSL is greater than or equal to the predetermined RSL, the positions of the first and second microwave antennas corresponding to the initial RSL are fixed in place.

In operation 315, the positions of the fixed first and second microwave antennas corresponding to the initial RSL being greater than or equal to the predetermined RSL are broadcast to the blockchain network. In some embodiments, operation 315 is optional.

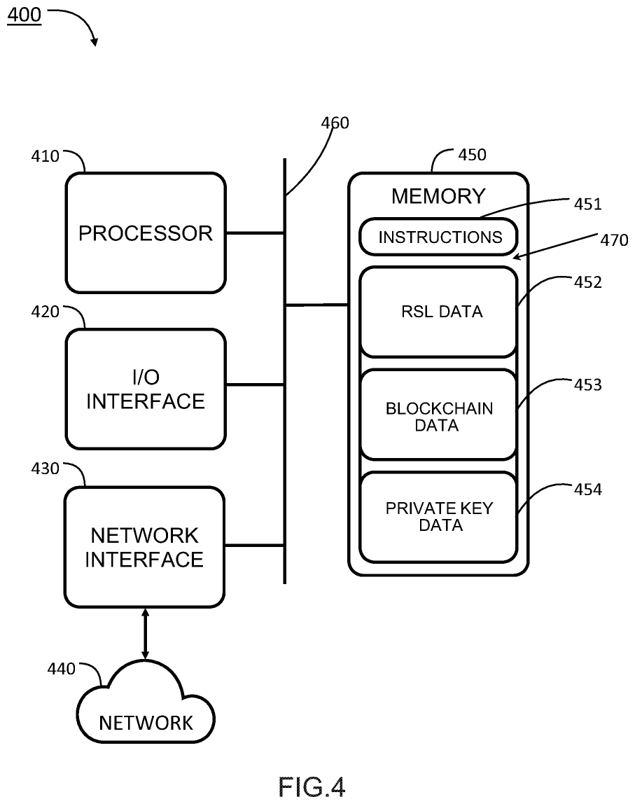

FIG. 4 is a block diagram of a system 400, including a non-transitory computer-readable medium 450 for implementing a method related to the setup of a network node via an autonomous vehicle, in accordance with some embodiments. In some embodiments, system 400 implements method 300. In some embodiments, system 400 implements method 200. In some embodiments, system 400 implements methods 200 and 300. System 400 includes a hardware processor 410 and a non-transitory, computer-readable storage medium 450 encoded with (i.e., storing) the computer program code 470 (i.e., a set of executable instructions). Computer-readable storage medium 450 is also encoded with instructions 451 for interfacing with different devices within a network. The processor 410 is electrically coupled to the computer-readable storage medium 450 via a bus 460. The processor 410 is also electrically coupled to an I/O interface 420 by bus 460. A network interface 430 is also electrically connected to processor 410 via bus 460. Network interface 430 is connected to a network 440, so processor 410 and computer-readable storage medium 450 can connect to external elements via network 440. Processor 410 is configured to execute the computer program code 470 encoded in the computer-readable storage medium 450 to cause system 400 to be usable for performing a portion or all of the operations as described in method 200.

In some embodiments, processor 410 is a central processing unit (CPU), a multi-processor, a distributed processing system, an application-specific integrated circuit (ASIC), or a suitable processing unit.

In some embodiments, the computer-readable storage medium 450 is an electronic, magnetic, optical, electromagnetic, infrared, or a semiconductor system (or apparatus or device). For example, the computer-readable storage medium 450 includes a semiconductor or solid-state memory, a magnetic tape, a removable computer diskette, a random-access memory (RAM), a read-only memory (ROM), a rigid magnetic disk, or an optical disk. In some embodiments using optical disks, the computer-readable storage medium 450 includes a compact disk-read-only memory (CD-ROM), a compact disk-read/write (CD-R/W), or a digital video disc (DVD).

In some embodiments, the storage medium 450 stores the computer program code 470 configured to cause system 400 to perform method 200. In some embodiments, the storage medium 450 also stores information needed for performing method 200 as well as information generated during performing method 200, such as RSL data 452, blockchain data 453, private key data 454, or a set of executable instructions to perform the operation of method 200.

In some embodiments, the storage medium 450 stores instructions 451 for interfacing with external components within the network. The instructions 451 enable processor 410 to generate instructions readable by the external components to effectively implement method 200.

System 400 includes I/O interface 420. I/O interface 420 is coupled to external circuitry. In some embodiments, I/O interface 420 includes a keyboard, keypad, mouse, trackball, trackpad, and/or cursor direction keys for communicating information and commands to processor 410.

System 400 also includes network interface 430 coupled to the processor 410. Network interface 430 allows system 400 to communicate with network 440, to which one or more other computer systems are connected. Network interface 430 includes wireless network interfaces such as BLUETOOTH, WIFI, WIMAX, GPRS, or WCDMA; or wired network interface such as ETHERNET, USB, or IEEE-1394. In some embodiments, method 200 is implemented in two or more systems 400, and information such as memory type, memory array layout, I/O voltage, and I/O pin location are exchanged between different systems 400 via network 440.

An aspect of this disclosure relates to a system for expanding a mobile network via an autonomous vehicle, in which the system includes a first microwave antenna, a radio antenna, a memory storing instructions, and at least one processor. The at least one processor is configured by the instructions to perform operations including receiving a network expansion request comprising configuration data, mapping a network expansion site based on the received network expansion request, generating a set of computer navigation instructions based on the network expansion request to be used by the autonomous vehicle to set up a microwave link and a radio network node for expanding the mobile network, selecting an autonomous vehicle among a plurality of autonomous vehicles based on the set of computer navigation instructions and the network expansion request, and deploying the selected autonomous vehicle to the network expansion site to autonomously set up the microwave link using the first microwave antenna and the radio network node using the radio antenna, where the first antenna and radio antenna are installed to the autonomous vehicle, and the microwave link and the radio node are part of the mobile network. In some embodiments, system further includes an Artificial Intelligence (A.I.) module configured to perform operations including receiving the network expansion request, mapping the network expansion site, generating the set of computer navigation instructions, selecting the autonomous vehicle among the plurality of autonomous vehicles, deploying the selected autonomous vehicle to the network expansion site, and autonomously setting up the microwave link using the microwave antenna and the radio network node using the radio antenna. In some embodiments, the operation of autonomously setting up the microwave link includes connecting the first microwave antenna and a second microwave antenna to a blockchain network, in which the first microwave antenna has at least one motor, and the second microwave antenna has at least one motor, using the first microwave antenna to obtain first positional data for the first microwave antenna, using the second microwave antenna to obtain second positional data for the second microwave antenna, setting a first alignment position based on the first positional data and a second alignment position based on the second positional data using the A.I. module, positioning the first microwave antenna according to the first alignment position using the at least one motor of the first microwave antenna, positioning the second microwave antenna according to the second alignment position using the at least one motor of the second microwave antenna, using the first microwave antenna or the second microwave antenna to measure a received signal level (RSL) corresponding to a signal level between the first and second microwave antennas while the antennas are aligned according to the first and second alignment positions, comparing the measured RSL to a predetermined RSL corresponding to an acceptable signal level using the A.I. module, and using the A.I. module to determine that the first and second alignment positions correspond to at least the acceptable signal level between the first and second microwave antennas when the measured RSL is greater than the predetermined RSL. In some embodiments, connecting the first microwave antenna and the second microwave antenna to the blockchain network includes connecting the first microwave antenna and the second microwave antenna to the Internet, automatically connecting, using a first private key and a second private key, the first microwave antenna and the second microwave antenna to the blockchain network in response to connecting to the Internet, automatically authenticating and authorizing, using the first private key and the second private key, the first microwave antenna and the second microwave antenna as a first node and a second node, respectively, of the blockchain network in response to connecting to the blockchain network, and automatically downloading from the blockchain network, data, ledgers, and transactions associated with the blockchain network using the first microwave antenna or the second microwave antenna. In some embodiments, the configuration data includes a configuration of the microwave link, including parameters to be configured such as: transmitter and receiver power output, antenna gain, antenna loss, antenna height, antenna elevation and the like, a configuration of the radio network node including technology band, frequency, Physical Cell Identification (PCI), node name, node identification, sector identification, radio unit interfaces, Internet Protocol (IP) configurations, power configurations and the like, antenna configuration data including number of antennas, antenna height, antenna azimuth, electrical tilt, mechanical tilt and the like, and duration of stay data. In some embodiments, the operations further include updating all nodes on the blockchain network in response to completing autonomously setting up the microwave link or the radio network node. In some embodiments, the operations further include triggering a smart contract based on the duration of stay data in which the smart contract causes a new transaction to be created that informs the other nodes on the blockchain network that the autonomous vehicle is initiating return procedures, disconnecting the microwave link and the radio network node link, and navigating the autonomous vehicle to a predetermined return location.

An aspect of this disclosure relates to a method for expanding a mobile network via an autonomous vehicle, where the method includes receiving a network expansion request containing configuration data, mapping a network expansion site based on the received network expansion request, generating a set of computer navigation instructions based on the network expansion request, to be used by the autonomous vehicle to set up a microwave link and a radio network node for expanding the mobile network, selecting, an autonomous vehicle among a plurality of autonomous vehicles based on the set of computer navigation instructions and the network expansion request, and deploying the selected autonomous vehicle to the network expansion site to autonomously set up the microwave link using the first microwave antenna and the radio network node using the radio antenna, where the microwave link and the radio node are part of the mobile network. In some embodiments, the method further includes using an Artificial Intelligence (A.I.) module to perform the steps of receiving the network expansion request, mapping the network expansion site, generating the set of computer navigation instructions, selecting the autonomous vehicle among the plurality of autonomous vehicles, deploying the selected autonomous vehicle to the network expansion site, and autonomously setting up the microwave link using the microwave antenna and the radio network node using the radio antenna. In some embodiments, autonomously setting up the microwave link includes connecting the first microwave antenna and a second microwave antenna to a blockchain network, where the first microwave antenna has at least one motor, and the second microwave antenna has at least one motor, using the first microwave antenna to obtain first positional data for the first microwave antenna, using the second microwave antenna to obtain second positional data for the second microwave antenna, using the A.I. module to set a first alignment position based on the first positional data, and a second alignment position based on the second positional data, using the at least one motor of the first microwave antenna to position the first microwave antenna according to the first alignment position, using the at least one motor of the second microwave antenna to position the second microwave antenna according to the second alignment position, using the first microwave antenna or the second microwave antenna to measure a received signal level (RSL) corresponding to a signal level between the first and second microwave antennas while the antennas are aligned according to the first and second alignment positions, using the A.I. module to compare the measured RSL to a predetermined RSL that corresponds to an acceptable signal level, and using the A.I. module to determine that the first and second alignment positions correspond to at least the acceptable signal level between the first and second microwave antennas when the measured RSL is greater than the predetermined RSL. In some embodiments, connecting the first microwave antenna and the second microwave antenna to the blockchain network includes connecting the first microwave antenna and the second microwave antenna to the Internet, automatically connecting, in response to connecting to the Internet, using a first private key and a second private key, the first microwave antenna and the second microwave antenna to the blockchain network, automatically authenticating and authorizing, in response to connecting to the blockchain network, using the first private key and the second private key, the first microwave antenna and the second microwave antenna as a first node and a second node, respectively, of the blockchain network, and automatically downloading from the blockchain network, by the first microwave antenna or the second microwave antenna, data, ledgers, and transactions associated with the blockchain network. In some embodiments, the configuration data includes a configuration of the microwave link, including parameters to be configured such as: transmitter and receiver power output, antenna gain, antenna loss, antenna height, antenna elevation and the like, a configuration of the radio network node including technology band, frequency, Physical Cell Identification (PCI), node name, node identification, sector identification, radio unit interfaces, Internet Protocol (IP) configurations, power configurations and the like, antenna configuration data including number of antennas, antenna height, antenna azimuth, electrical tilt, mechanical tilt and the like, and duration of stay data. In some embodiments, the method further includes updating all nodes on the blockchain network in response to completing autonomously setting up the microwave link or the radio network node. In some embodiments, the method further includes triggering a smart contract based on the duration of stay data, in which the smart contract causes a new transaction to be created that informs the other nodes on the blockchain network that the autonomous vehicle is initiating return procedures, disconnecting the microwave link and the radio network node link, and navigating the autonomous vehicle to a predetermined return location.

An aspect of this disclosure relates to a non-transitory computer-readable medium storing instructions that, when executed by at least one processor, cause the at least one processor to perform operations for expanding a mobile network via an autonomous vehicle, in which the operations include receiving a network expansion request comprising configuration data, mapping a network expansion site based on the received network expansion request, generating a set of computer navigation instructions based on the network expansion request to be used by the autonomous vehicle to set up a microwave link and a radio network node for expanding the mobile network, selecting an autonomous vehicle among a plurality of autonomous vehicles based on the set of computer navigation instructions and the network expansion request, and deploying the selected autonomous vehicle to the network expansion site to autonomously set up the microwave link using the first microwave antenna and the radio network node using the radio antenna, where the microwave link and the radio node are part of the mobile network. In some embodiments, the operations further include using an Artificial Intelligence (A.I.) module perform the operations of receiving the network expansion request, mapping the network expansion site, generating the set of computer navigation instructions, selecting the autonomous vehicle among the plurality of autonomous vehicles, deploying the selected autonomous vehicle to the network expansion site, and autonomously setting up the microwave link using the microwave antenna and the radio network node using the radio antenna. In some embodiments, autonomously setting up the microwave link includes connecting a first microwave antenna having at least one motor and a second microwave antenna having at least one motor to a blockchain network, using the first microwave antenna to obtain first positional data for the first microwave antenna, using the second microwave antenna to obtain second positional data for the second microwave antenna, using the A.I. module to set a first alignment position based on the first positional data, and a second alignment position based on the second positional data, using the at least one motor of the first microwave antenna to position the first microwave antenna according to the first alignment position, using the at least one motor of the second microwave antenna to position the second microwave antenna according to the second alignment position, using the first microwave antenna or the second microwave antenna to measure a received signal level (RSL) corresponding to a signal level between the first and second microwave antennas while the antennas are aligned according to the first and second alignment positions, using the A.I. module to compare the measured RSL to a predetermined RSL corresponding to an acceptable signal level, and using the A.I. module to determine that the first and second alignment positions correspond to at least the acceptable signal level between the first and second microwave antennas when the measured RSL is greater than the predetermined RSL. In some embodiments, connecting the first microwave antenna and the second microwave antenna to the blockchain network includes connecting the first microwave antenna and the second microwave antenna to the Internet, automatically connecting, in response to connecting to the Internet, using a first private key and a second private key, the first microwave antenna and the second microwave antenna to the blockchain network, automatically authenticating and authorizing, in response to connecting to the blockchain network, using the first private key and the second private key, the first microwave antenna and the second microwave antenna as a first node and a second node, respectively, of the blockchain network, and automatically downloading from the blockchain network, by the first microwave antenna or the second microwave antenna, data, ledgers, and transactions associated with the blockchain network. In some embodiments, the configuration data includes a configuration of the microwave link, including parameters to be configured such as: transmitter and receiver power output, antenna gain, antenna loss, antenna height, antenna elevation and the like, a configuration of the radio network node including technology band, frequency, Physical Cell Identification (PCI), node name, node identification, sector identification, radio unit interfaces, Internet Protocol (IP) configurations, power configurations and the like, antenna configuration data including number of antennas, antenna height, antenna azimuth, electrical tilt, mechanical tilt and the like, and duration of stay data. In some embodiments, the operations further include updating all nodes on the blockchain network in response to completing autonomously setting up the microwave link or the radio network node, triggering a smart contract based on the duration of stay data, where the smart contract causes a new transaction to be created that informs the other nodes on the blockchain network that the autonomous vehicle is initiating return procedures, disconnecting the microwave link and the radio network node link, and navigating the autonomous vehicle to a predetermined return location.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes or achieving the same advantages of the embodiments introduced herein. Those skilled in the art should also realize that such equivalent constructions do not depart from the spirit and scope of the present disclosure and that they may make various changes, substitutions, and alterations herein without departing from the spirit and scope of the present disclosure.

1. A system for expanding a mobile network via an autonomous vehicle, the system comprising:
a first microwave antenna;
a radio antenna;
a memory storing instructions; and
at least one processor configured by the instructions to perform operations comprising:
receiving a network expansion request comprising configuration data;
mapping, based on the received network expansion request, a network expansion site;
generating, based on the network expansion request, a set of computer navigation instructions to be used by the autonomous vehicle to set up a microwave link and a radio network node for expanding the mobile network;
selecting, based on the set of computer navigation instructions and the network expansion request, an autonomous vehicle among a plurality of autonomous vehicles; and
deploying the selected autonomous vehicle to the network expansion site to autonomously set up the microwave link using the first microwave antenna and the radio network node using the radio antenna,
wherein
the first antenna and radio antenna are installed to the autonomous vehicle, and
the microwave link and the radio node are part of the mobile network.

2. The system of claim 1, further comprising an Artificial Intelligence (A.I.) module configured to perform the operations of:
receiving the network expansion request;
mapping the network expansion site;
generating the set of computer navigation instructions;
selecting the autonomous vehicle among the plurality of autonomous vehicles;
deploying the selected autonomous vehicle to the network expansion site; and
autonomously setting up the microwave link using the microwave antenna and the radio network node using the radio antenna.

3. The system of claim 2, wherein the operation of autonomously setting up the microwave link comprises:
connecting the first microwave antenna and a second microwave antenna to a blockchain network,
wherein the first microwave antenna comprises at least one motor, and the second microwave antenna comprises at least one motor;
obtaining, using the first microwave antenna, first positional data of the first microwave antenna;
obtaining, using the second microwave antenna, second positional data of the second microwave antenna;
setting, using the A.I. module, a first alignment position based on the first positional data and a second alignment position based on the second positional data;
positioning, using the at least one motor of the first microwave antenna, the first microwave antenna according to the first alignment position;
positioning, using the at least one motor of the second microwave antenna, the second microwave antenna according to the second alignment position;
measuring, using the first microwave antenna or the second microwave antenna, a received signal level (RSL) corresponding to a signal level between the first and second microwave antennas while the antennas are aligned according to the first and second alignment positions;
comparing, using the A.I. module, the measured RSL to a predetermined RSL corresponding to an acceptable signal level; and
determining, using the A.I. module, that the first and second alignment positions correspond to at least the acceptable signal level between the first and second microwave antennas when the measured RSL is greater than the predetermined RSL.

4. The system of claim 3, wherein connecting the first microwave antenna and the second microwave antenna to the blockchain network, comprises:
connecting the first microwave antenna and the second microwave antenna to the Internet;
automatically connecting, in response to connecting to the Internet, using a first private key and a second private key, the first microwave antenna and the second microwave antenna to the blockchain network;
automatically authenticating and authorizing, in response to connecting to the blockchain network, using the first private key and the second private key, the first microwave antenna and the second microwave antenna as a first node and a second node, respectively, of the blockchain network; and
automatically downloading from the blockchain network, by the first microwave antenna or the second microwave antenna, data, ledgers, and transactions associated with the blockchain network.

5. The system of claim 4, wherein the configuration data comprises a configuration of the microwave link, a configuration of the radio network node, antenna configuration data, and duration of stay data.

6. The system of claim 5, wherein the operations further comprise:
updating all nodes on the blockchain network in response to completing autonomously setting up the microwave link or the radio network node.

7. The system of claim 5, wherein the operations further comprise:
triggering a smart contract based on the duration of stay data, wherein the smart contract causes a new transaction to be created that informs the other nodes on the blockchain network that the autonomous vehicle is initiating return procedures;
disconnecting the microwave link and the radio network node link; and
navigating the autonomous vehicle to a predetermined return location.

8. A method for expanding a mobile network via an autonomous vehicle, the method comprising:
receiving a network expansion request comprising configuration data;
mapping, based on the received network expansion request, a network expansion site;
generating, based on the network expansion request, a set of computer navigation instructions to be used by the autonomous vehicle to set up a microwave link and a radio network node for expanding the mobile network;
selecting, based on the set of computer navigation instructions and the network expansion request, an autonomous vehicle among a plurality of autonomous vehicles; and
deploying the selected autonomous vehicle to the network expansion site to autonomously set up the microwave link using the first microwave antenna and the radio network node using the radio antenna,
wherein
the microwave link and the radio node are part of the mobile network.

9. The method of claim 8, further comprising using an Artificial Intelligence (A.I.) module to perform the steps of:
receiving the network expansion request;
mapping the network expansion site;
generating the set of computer navigation instructions;
selecting the autonomous vehicle among the plurality of autonomous vehicles;
deploying the selected autonomous vehicle to the network expansion site; and
autonomously setting up the microwave link using the microwave antenna and the radio network node using the radio antenna.

10. The method of claim 9, wherein autonomously setting up the microwave link comprises:
connecting the first microwave antenna and a second microwave antenna to a blockchain network, wherein the first microwave antenna comprises at least one motor, and the second microwave antenna comprises at least one motor;
obtaining, using the first microwave antenna, first positional data of the first microwave antenna;
obtaining, using the second microwave antenna, second positional data of the second microwave antenna;
setting, using the A.I. module, a first alignment position based on the first positional data, and a second alignment position based on the second positional data;
positioning, using the at least one motor of the first microwave antenna, the first microwave antenna according to the first alignment position;
positioning, using the at least one motor of the second microwave antenna, the second microwave antenna according to the second alignment position;
measuring, using the first microwave antenna or the second microwave antenna, a received signal level (RSL) corresponding to a signal level between the first and second microwave antennas while the antennas are aligned according to the first and second alignment positions;
comparing, using the A.I. module, the measured RSL to a predetermined RSL corresponding to an acceptable signal level; and
determining, using the A.I. module, that the first and second alignment positions correspond to at least the acceptable signal level between the first and second microwave antennas when the measured RSL is greater than the predetermined RSL.

11. The method of claim 10, wherein connecting the first microwave antenna and the second microwave antenna to the blockchain network comprises:
connecting the first microwave antenna and the second microwave antenna to the Internet;
automatically connecting, in response to connecting to the Internet, using a first private key and a second private key, the first microwave antenna and the second microwave antenna to the blockchain network;
automatically authenticating and authorizing, in response to connecting to the blockchain network, using the first private key and the second private key, the first microwave antenna and the second microwave antenna as a first node and a second node, respectively, of the blockchain network; and
automatically downloading from the blockchain network, by the first microwave antenna or the second microwave antenna, data, ledgers, and transactions associated with the blockchain network.

12. The method of claim 11, wherein the configuration data comprises a configuration of the microwave link, a configuration of the radio network node, antenna configuration data, and duration of stay data.

13. The method of claim 12, further comprising:
updating all nodes on the blockchain network in response to completing autonomously setting up the microwave link or the radio network node.

14. The method of claim 12, further comprising:
triggering a smart contract based on the duration of stay data, wherein the smart contract causes a new transaction to be created that informs the other nodes on the blockchain network that the autonomous vehicle is initiating return procedures;
disconnecting the microwave link and the radio network node link; and
navigating the autonomous vehicle to a predetermined return location.

15. A non-transitory computer-readable medium storing instructions that, when executed by at least one processor, cause the at least one processor to perform operations for expanding a mobile network via an autonomous vehicle, the operations comprising:
receiving a network expansion request comprising configuration data;
mapping, based on the received network expansion request, a network expansion site;
generating, based on the network expansion request, a set of computer navigation instructions to be used by the autonomous vehicle to set up a microwave link and a radio network node for expanding the mobile network;
selecting, based on the set of computer navigation instructions and the network expansion request, an autonomous vehicle among a plurality of autonomous vehicles; and
deploying the selected autonomous vehicle to the network expansion site to autonomously set up the microwave link using the first microwave antenna and the radio network node using the radio antenna,
wherein
the microwave link and the radio node are part of the mobile network.

16. The non-transitory computer-readable medium of claim 15, wherein the operations further comprise using an Artificial Intelligence (A.I.) module perform the operations of:
receiving the network expansion request;
mapping the network expansion site;
generating the set of computer navigation instructions;
selecting the autonomous vehicle among the plurality of autonomous vehicles;
deploying the selected autonomous vehicle to the network expansion site; and
autonomously setting up the microwave link using the microwave antenna and the radio network node using the radio antenna.

17. The non-transitory computer-readable medium of claim 16, wherein the operation of autonomously setting up the microwave link comprises:
connecting the first microwave antenna and a second microwave antenna to a blockchain network, wherein the first microwave antenna comprises at least one motor, and the second microwave antenna comprises at least one motor;
obtaining, using the first microwave antenna, first positional data of the first microwave antenna;
obtaining, using the second microwave antenna, second positional data of the second microwave antenna;
setting, using the A.I. module, a first alignment position based on the first positional data, and a second alignment position based on the second positional data;
positioning, using the at least one motor of the first microwave antenna, the first microwave antenna according to the first alignment position;
positioning, using the at least one motor of the second microwave antenna, the second microwave antenna according to the second alignment position;
measuring, using the first microwave antenna or the second microwave antenna, a received signal level (RSL) corresponding to a signal level between the first and second microwave antennas while the antennas are aligned according to the first and second alignment positions;
comparing, using the A.I. module, the measured RSL to a predetermined RSL corresponding to an acceptable signal level; and
determining, using the A.I. module, that the first and second alignment positions correspond to at least the acceptable signal level between the first and second microwave antennas when the measured RSL is greater than the predetermined RSL.

18. The non-transitory computer-readable medium of claim 17, wherein the operation of connecting the first microwave antenna and the second microwave antenna to the blockchain network comprises:
connecting the first microwave antenna and the second microwave antenna to the Internet;
automatically connecting, in response to connecting to the Internet, using a first private key and a second private key, the first microwave antenna and the second microwave antenna to the blockchain network;
automatically authenticating and authorizing, in response to connecting to the blockchain network, using the first private key and the second private key, the first microwave antenna and the second microwave antenna as a first node and a second node, respectively, of the blockchain network; and
automatically downloading from the blockchain network, by the first microwave antenna or the second microwave antenna, data, ledgers, and transactions associated with the blockchain network.

19. The non-transitory computer-readable medium of claim 18, wherein the configuration data comprises a configuration of the microwave link, a configuration of the radio network node, antenna configuration data, and duration of stay data.

20. The non-transitory computer-readable medium of claim 19, wherein the operations further comprise:
updating all nodes on the blockchain network in response to completing autonomously setting up the microwave link or the radio network node;
triggering a smart contract based on the duration of stay data, wherein the smart contract causes a new transaction to be created that informs the other nodes on the blockchain network that the autonomous vehicle is initiating return procedures;
disconnecting the microwave link and the radio network node link; and
navigating the autonomous vehicle to a predetermined return location.
